(19) United States
(12) Patent Application Publication
(10) Pub. No.: US 2018/0077900 A1
(43) Pub. Date: Mar. 22, 2018

(54) PET DRYING ROOM

(71) Applicant: EUI SU KANG, BUSAN (KR)

(72) Inventor: EUI SU KANG, BUSAN (KR)

(21) Appl. No.: 15/269,998

(22) Filed: Sep. 20, 2016

(51) Int. Cl. A01K 13/00

(52) U.S. Cl. CPC A01K 13/001

(57) ABSTRACT

A pet drying room, including: a drying room having a space formed to accommodate a pet therein; a mounting hole perforated in the front portion of the drying room; a discharge hole perforated in the rear portion of the drying room; and a dust collection filter positioned at the rear side of the drying room to close the discharge hole and having a plurality of fine holes formed therein. After accommodating a pet in the drying room, a conventional hair dryer is attached to the mounting hole to inject warm air to the inside of the drying room and conveniently dry the pet in the drying room. Therefore, various electrical and mechanical elements previously used in conventional pet dryer devices are eliminated, thereby significantly reducing unit costs, such that the pet drying room can be used by normal home users without the burden of expenses and ensure versatile use thereof.

### BACKGROUND OF THE INVENTION

### Field of the Invention

The present invention relates to a pet drying room and, more particularly, to a pet drying room, in which a pet is accommodated in an internal space of a drying room and then a dryer available at home is provided to the drying room through a mounting hole so as to be operated to inject warm air to the inside of the drying room and conveniently dry the pet accommodated in the drying room. Therefore, various electrical and mechanical elements previously used in the prior art pet dryer devices are not required, thereby largely reducing unit costs, such that the pet drying room can be used by normal home users without the burden of expenses and ensure versatile use thereof.

### Background Art

Recently, many people have various pets such as dogs, cats and the like at home and thus there is a tendency towards the development of businesses relating to such pets, for example, animal hospitals and the like.

Meanwhile, it is necessary to take much care of cleanliness when people keep hairy pets indoors and thus it is necessary to bathe the pets frequently so as to remove bad smell and keep surroundings clean by removing germs, ticks, dust and the like included in the hair of the pets.

However, in the process of drying the hair of the pets after bathing the pets, when the pets intensely shake water off, hair of the pets and water drops are scattered around, making the surroundings dirty. In addition, the pets are not likely to stay calm but run away or move. Therefore, there is problems that it takes much time and effort to dry the wet hair of the pets by means of towels, dryers and the like.

In order to solve the above problems, there have developed a drying device for pets, in which a pet is placed in a sealed rectangular box and then warm air is supplied to the inside of the rectangular box so as to dry the hair of the pet.

However, the prior art drying device for pets still has a problem that since the drying device includes a heating means for supplying a heat source, a blower means for supplying the heat to the inside of the rectangular box, and various electrical devices, sensors and the like for controlling the operations of the heating means and the blower means, increasing the manufacturing costs of the device, this drying device for pets is very expensive and thus cannot be used by normal home users.

Furthermore, in the case where the pet has long hair, it is necessary to comb the hair during the drying process so as to prevent the tangles of the long hair. However, since the prior art drying device for pets has a structure, in which the rectangular box is sealed while the pet is accommodated therein, it is impossible to comb the hair of the pet during the drying process. Thus, as the drying of the hair of the pet is finished, the hair is tangled. Therefore, the prior art drying device for pets still has another problem that it is necessary to inconveniently comb the tangled hair after the drying process.

Besides, the prior art drying device for pets has a further problem that because of the plurality of electrical and mechanical constituent elements, the whole volume of the device is increased and, accordingly, seriously limited in the storage and installation places thereof.

### SUMMARY OF THE INVENTION

Accordingly, the present invention has been made to solve the above-mentioned problems occurring in the prior arts, and it is an objective of the present invention to provide a pet drying room, in which a pet is accommodated in a space of a drying room and then a dryer available at home is provided to the drying room through a mounting hole so as to be operated to inject warm air to the inside of the drying room and conveniently dry the pet accommodated in the drying room. Therefore, various electrical and mechanical elements previously used in the prior art pet dryer devices are not required, thereby largely reducing unit costs, such that the pet drying room can be used by normal home users without the burden of expenses and ensure versatile use thereof.

In addition, it is another objective of the present invention to provide a pet drying room, in which, in the process of drying a pet, a user can put hands in the pet drying room through introduction holes formed in both side surfaces of the drying room and comb the hair of the pet so as to prevent the tangles of the long hair of the pet during the drying process.

Furthermore, it is still another objective of the present invention to provide a pet drying room, in which, in the process of drying a pet, floating hair can be collected through a dust collection filter positioned at the rear side of the drying room such that it is possible to prevent various diseases (allergy reactions, respiratory diseases and the like), which may be caused by the scattering of the pet hair.

Besides, it is a further objective of the present invention to provide a pet drying room, which can be conveniently spread out at the time of use while being simply folded so as to be minimized in volume at the time of storing after the use, thereby providing the convenience of storage and maintenance to users.

To accomplish the above objectives, according to the present invention, there is provided a pet drying room, including: a drying room having a space formed to accommodate a pet therein; a mounting hole perforated in the front portion of the drying room; a discharge hole perforated in the rear portion of the drying room; and a dust collection filter positioned at the rear side of the drying room so as to close the discharge hole and having a plurality of fine holes formed therein, wherein the drying room includes: a rotation frame formed in a reversed “U” shape and having rotation protrusions, which are formed at both ends thereof so as to be respectively extended inwards, and threads, which are formed on the outer circumferences of the rotation protrusions; a plurality of support frames formed in a reversed “U” shape and respectively having rotation holes formed at both ends such that the rotation protrusion formed at one end of the rotation frame is inserted into the rotation hole formed at one end of each of the plurality of support frames and the rotation protrusion formed at the other end of the rotation frame is inserted into the rotation hole formed at the other end of each of the plurality of support frames; fixing nuts respectively coupled to the rotation protrusions, which are formed at the both ends of the rotation frame, so as to prevent the separation of the support frames, which are inserted into the rotation protrusions of the rotation frame; and closing panels formed between the rotation frame and the support frame, which is closest to the rotation frame, and between the other support frames so as to close space portions between the rotation frame and the support frame, which is closest to the rotation frame, and between the other support frames, wherein, if the rotation frame is spread out (rotated) and comes into close contact with the floor, the support frame, which is connected to the rotation frame, and the other support frame, which is connected to the support frame connected to the rotation frame, are rotated together with the rotation frame in sequence by the closing panels, such that a sealed space is formed to accommodate a pet therein, and, to the contrary, if the rotation frame is folded, the support frame, which is connected to the rotation frame, and the other support frame, which is connected to the support frame connected to the rotation frame, are rotated together with the rotation frame such that a sealed space is opened.

In addition, the pet drying room further includes introduction holes formed at both sides of the drying room such that a user can put hands in the drying room through the introduction holes.

Furthermore, the pet drying room further includes a flexible connection pipe, of which the inside is perforated, and having one end to be inserted into the mounting hole of the drying room so as to communicate with the inside of the drying room and the other end, through which a dryer is inserted.

Moreover, the pet drying room further includes a dispersion cover inserted and fixed in the mounting hole of the drying room and having an introduction groove, into which the dryer can be inserted, and a plurality of introduction holes formed in the inner peripheral surface and the front surface of the introduction groove, wherein, if the dryer is operated after inserting and fixing the dryer in the introduction groove of the dispersion cover, hot wind is dispersed and discharged through the plurality of introduction holes, which are provided to the dispersion cover, so as to be uniformly dispersed and supplied to the inside of the drying room.

Besides, the pet drying room further includes a suction pipe positioned at the rear side of the drying room and of which one end is connected to and thus communicates with the discharge hole, which is provided with a dust collection filter.

In addition, the closing panels employ any one selected from a soft material or a hard material or the combination thereof.

Furthermore, the pet drying room includes: a fixing band, of which one end is coupled to the support frame; and

a fixing hook coupled to the other end of the fixing band, wherein the fixing hook is coupled to the rotation frame so as to prevent the rotation of the rotation frame.

Besides, the pet drying room further includes: a coupling band, of which one end portion is coupled and fixed to the rotation frame; a female VELCRO® strip (one of hook and loop strip) formed on one surface of the center portion of the coupling band; and a male VELCRO® (other of hook and loop strip) formed on one surface of the other end portion of the coupling band, wherein, in a state, in which the rotation frame is folded, the hook strip (male VELCRO® strip) formed at the end of the coupling band is coupled to the loop strip (female VELCRO® strip), after passing the end of the coupling band through the support frame positioned at the rear side of the drying room, such that the volume of the drying room is reduced so as to be easily stored.

As for the pet drying room according to the present invention described as above, a pet is accommodated and then a dryer available at home is provided through a mounting hole so as to be operated to inject warm air to the inside of the drying room and conveniently dry the pet accommodated in the drying room. Therefore, various electrical and mechanical elements previously used in the prior art pet dryer devices are not required, thereby largely reducing unit costs, such that the pet drying room can be used by normal home users without the burden of expenses and ensure versatile use thereof.

In addition, in the process of drying a pet, a user can put hands in the pet drying room through introduction holes formed in both side surfaces of the drying room and comb the hair of the pet so as to prevent the tangles of the long hair of the pet from occurring during the drying process.

Furthermore, in the process of drying a pet, floating hair can be collected through a dust collection filter positioned at the rear side of the drying room such that it is possible to prevent various diseases (allergy reactions, respiratory diseases and the like), which may be caused by the scattering of the pet hair.

Besides, the pet drying room according to the present invention can be conveniently spread out at the time of use while being simply folded so as to be minimized in volume at the time of storing after use, thereby providing the convenience of storage and maintenance to users.

### BRIEF DESCRIPTION OF DRAWINGS

FIG. 1 is a perspective view of a pet drying room according to a first embodiment of the present invention.

FIG. 2 is an exploded perspective view of the pet drying room shown in FIG. 1.

FIG. 3 is a perspective view of a pet drying room according to a second embodiment of the present invention.

FIG. 4 is a perspective view of a pet drying room according to a third embodiment of the present invention.

FIG. 5 is a perspective view of a pet drying room according to a fourth embodiment of the present invention, and

FIGS. 6A-F are diagrams for showing a use state of the pet drying room shown in FIG. 1.

### BRIEF EXPLANATION OF REFERENCE SIGNS

| 1: dryer | 2: mat |
|---|---|
| 3: VELCRO ® (hook and loop strip) | |
| 10: drying room | 11: rotation frame |
| 11a: rotation protrusions | 11b: thread |
| 12: support frame | 13: fixing nut |
| 14: closing panels | 20: mounting hole |
| 30: discharge hole | 40: dust collection filter |
| 41: holes | 51: introduction holes |
| 52: wristlets | 60: connection pipe |
| 70: dispersion cover | 71: introduction groove |
| 72: introduction holes | 80: suction pipe |
| 90: suction fan | 111: blower fans |
| 112: control box | 121: fixing band |
| 122: fixing hook | 131: coupling band |
| 132: female VELCRO ® strip | 133: male VELCRO ® strip |

100: pet drying room

### DETAILED DESCRIPTION OF THE PREFERRED EMBODIMENTS

Reference will be now made in detail to the preferred embodiments of the present invention with reference to the accompanying drawings, wherein the detailed explanation of well-known functions or features will be omitted in the description of the present invention if those are considered to make the gist of the present invention unnecessarily confused.

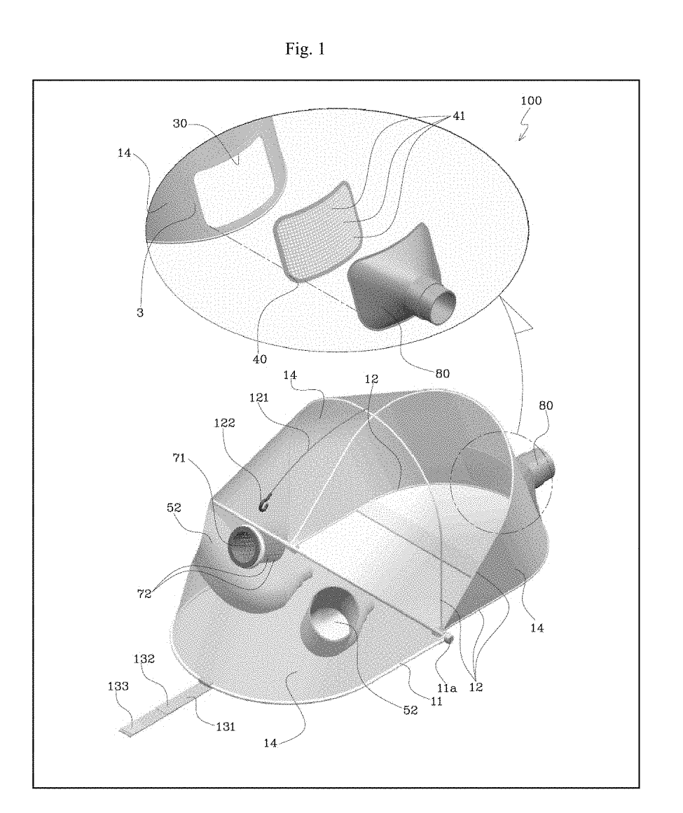

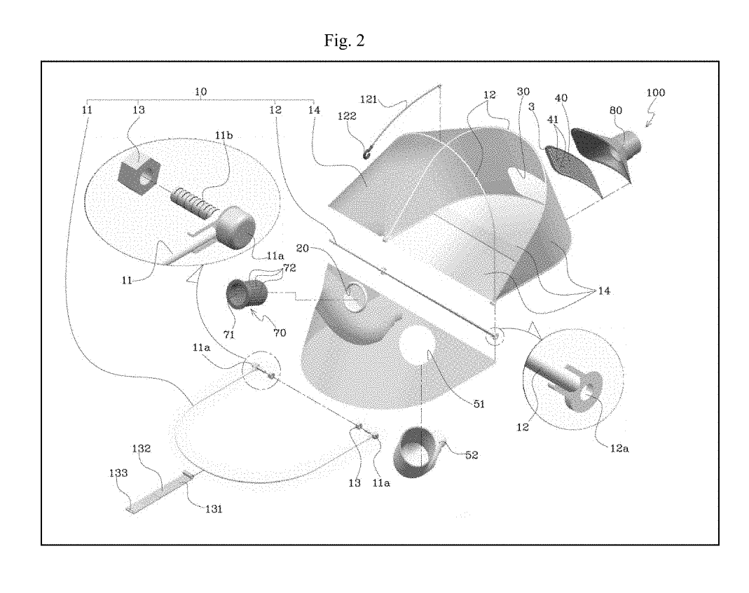

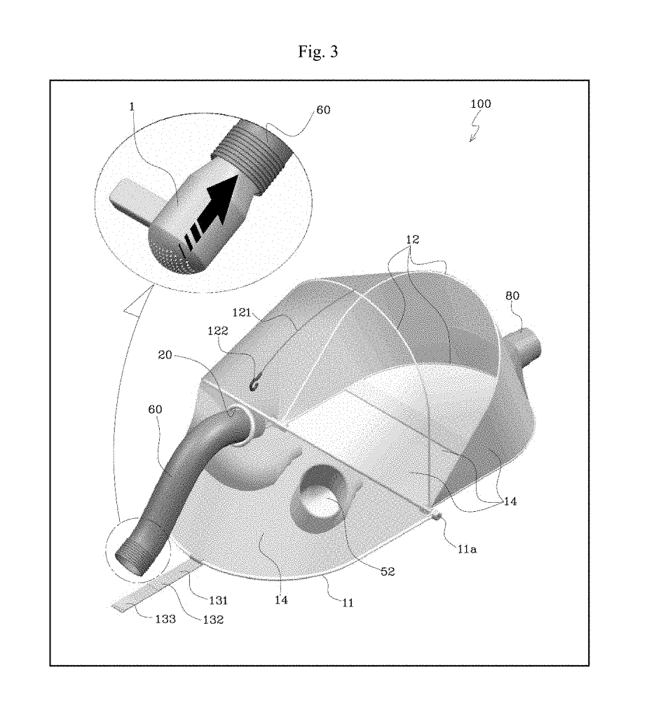

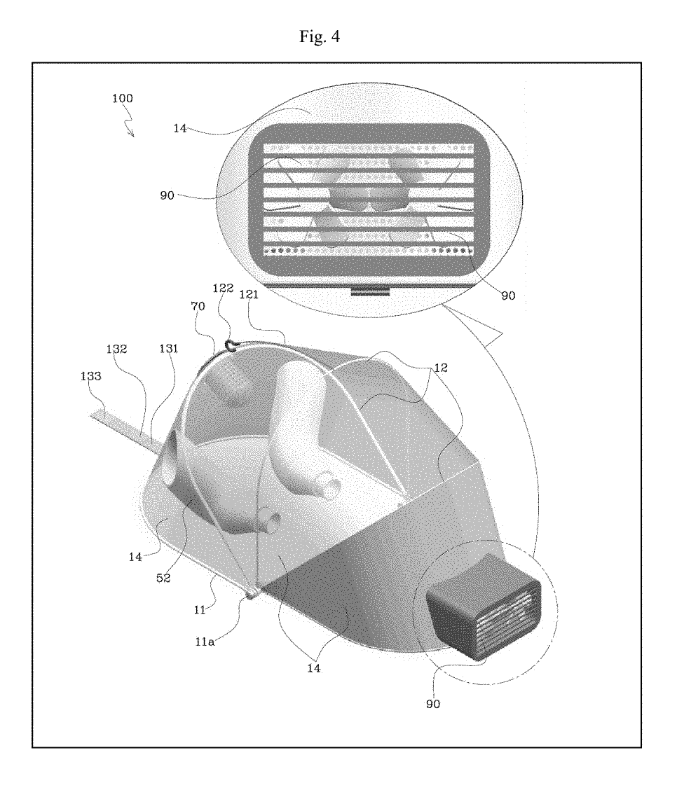

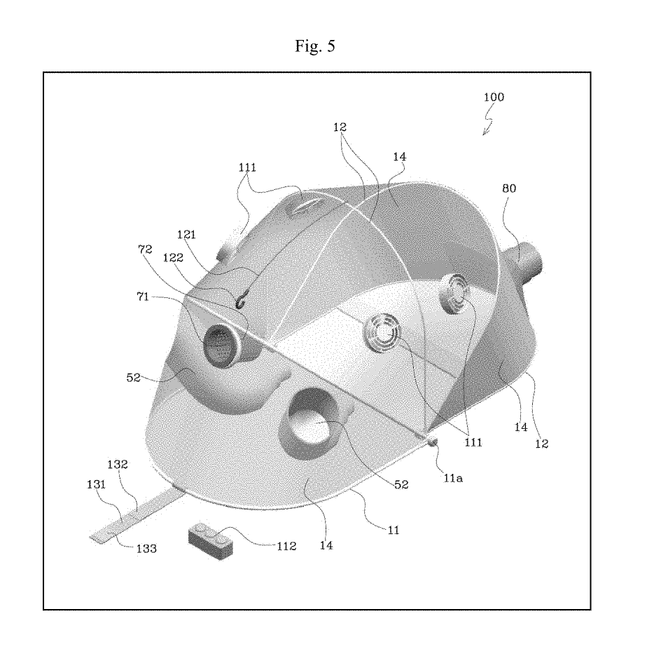

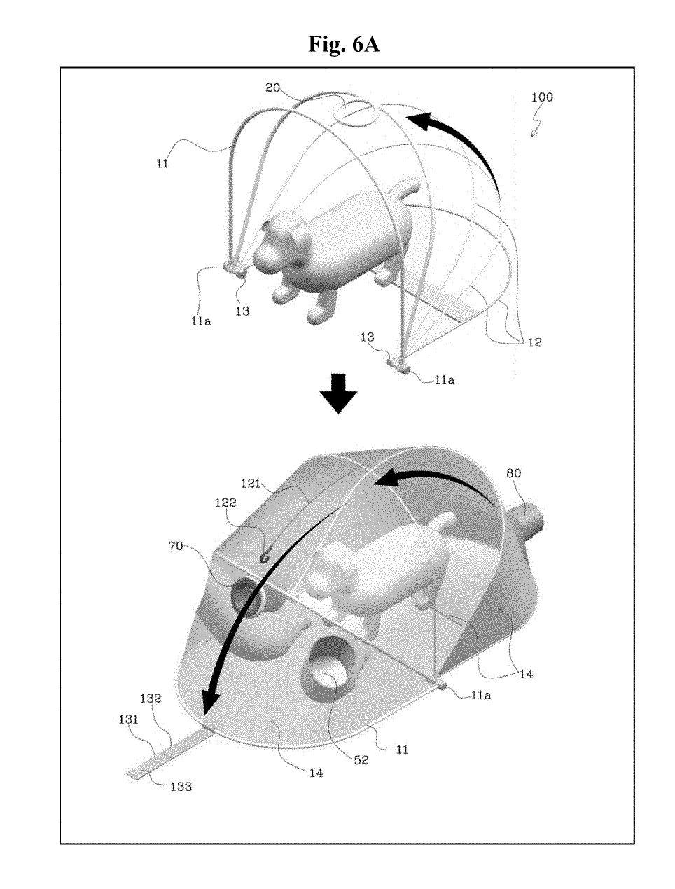

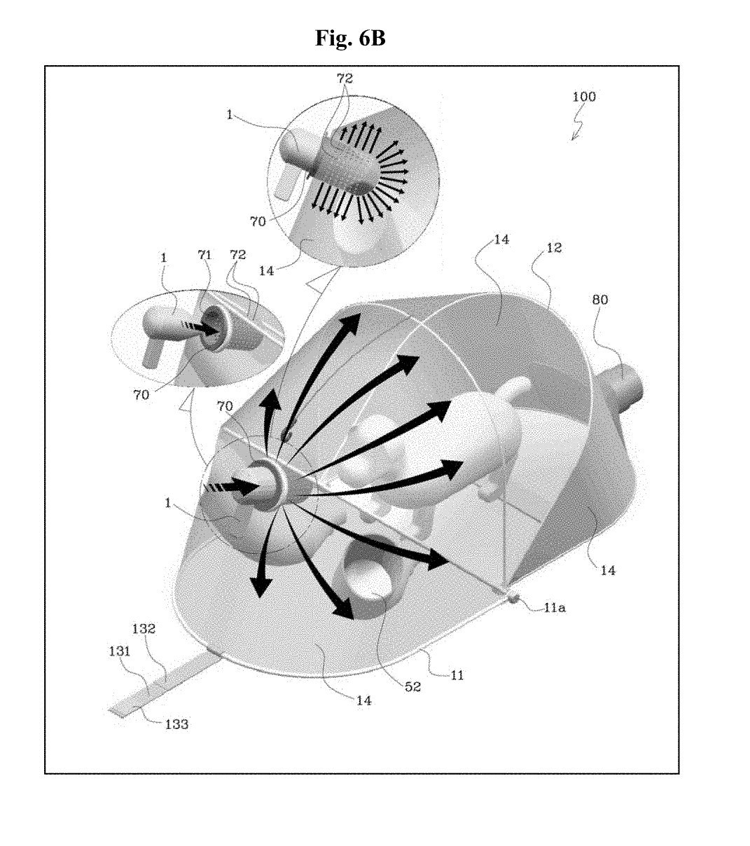

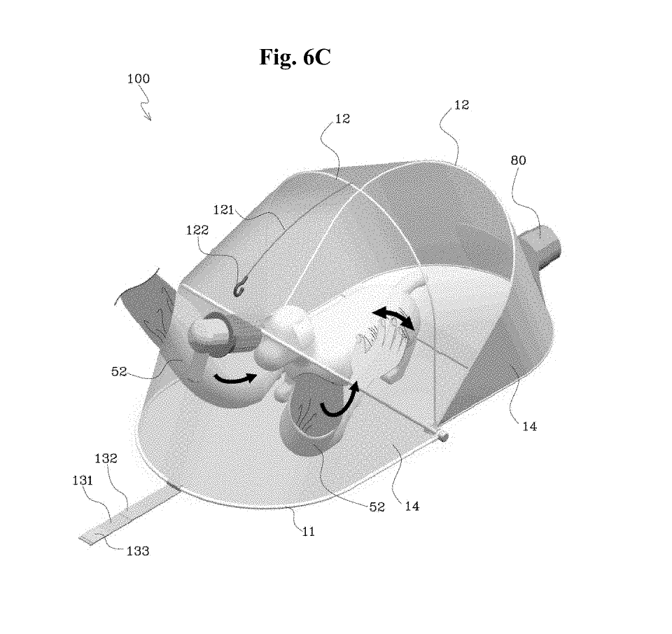

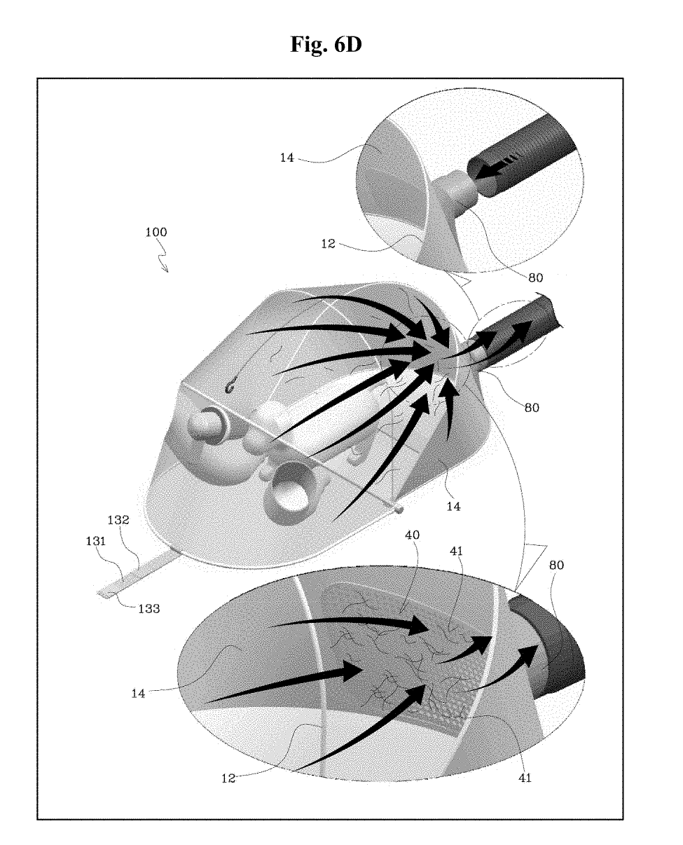

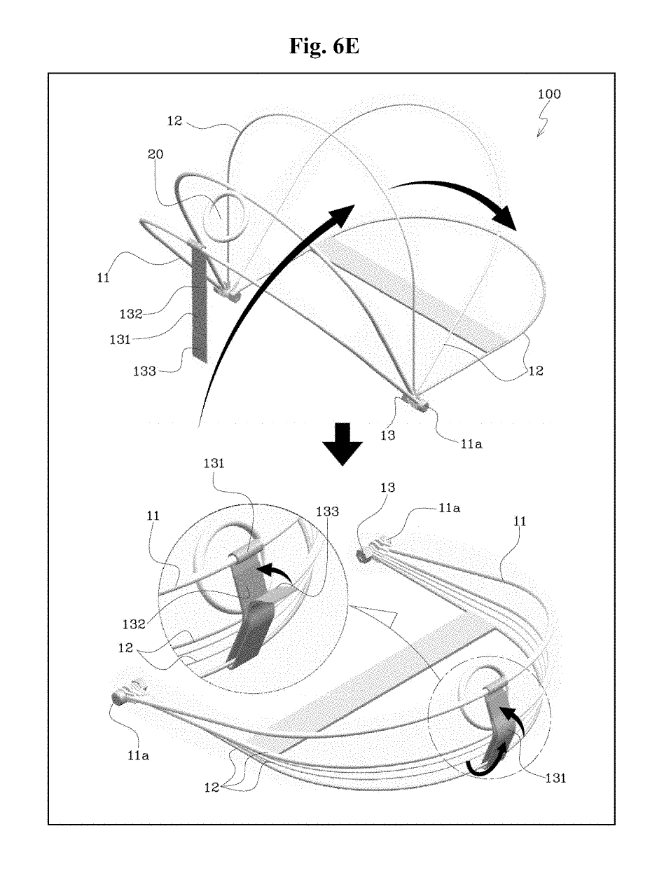

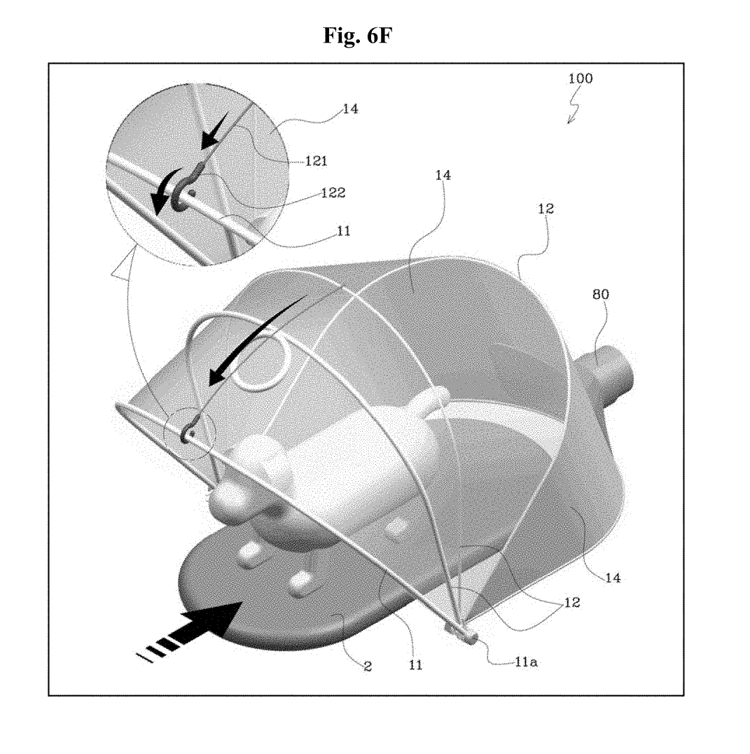

FIG. 1 to FIGS. 6A-F show pet drying rooms according to preferred embodiments of the present invention, in which FIG. 1 is a perspective view of a pet drying room according to a first embodiment of the present invention, FIG. 2 is an exploded perspective view of the pet drying room shown in FIG. 1, FIG. 3 is a perspective view of a pet drying room according to a second embodiment of the present invention, FIG. 4 is a perspective view of a pet drying room according to a third embodiment of the present invention, FIG. 5 is a perspective view of a pet drying room according to a fourth embodiment of the present invention, and FIGS. 6A-F are diagrams for showing a use state of the pet drying room shown in FIG. 1.

As shown in FIG. 1 to FIGS. 6A-F, a pet drying room 100 according to embodiments of the present invention includes a drying room 10, a mounting hole 20, a discharge hole 30 and a dust collection filter 40.

Referring to FIG. 1 and FIG. 2, the drying room 10 is formed with a space for accommodating a pet therein, and includes a rotation frame 11 formed in a reversed “U” shape and having rotation protrusions 11a, which are formed at both ends thereof so as to be respectively extended inwards, and threads 11b, which are formed on the outer circumferences of the rotation protrusions 11a, a plurality of support frames 12 formed in a reversed “U” shape and respectively having rotation holes 12a formed at both ends such that the rotation protrusion 11a, which is formed at one end of the rotation frame 11, is inserted into the rotation hole 12a, which is formed at one end of each of the plurality of support frames 12, and the rotation protrusion 11a, which is formed at the other end of the rotation frame 11, is inserted into the rotation hole 12a, which is formed at the other end of each of the plurality of support frames 12, fixing nuts 13 respectively coupled to the rotation protrusions 11a, which are formed at the both ends of the rotation frame 11, so as to prevent the separation of the support frames 12, which are inserted into the rotation protrusions 11a of the rotation frame 11, and closing panels 14 formed between the rotation frame 11 and the support frame 12, which is closest to the rotation frame 11, and between the other support frames 12 so as to close space portions between the rotation frame 11 and the support frame 12, which is closest to the rotation frame 11, and between the other support frames 12.

That is, as shown in FIG. 6A, in order to use the drying room 10, if the rotation frame 11 is rotated in one direction and comes into close contact with the floor, the support frame 12, which is connected to the rotation frame 11, and the other support frame 12, which is connected to the support frame 12 connected to the rotation frame 11, are rotated together with the rotation frame 11 in sequence by the closing panels 14, such that a sealed space is formed to accommodate a pet therein.

Herein, the support frame 12 positioned at the rear side of the drying room 10 is in close contact with and fixed on the floor regardless of the rotation of the rotation frame 11 such that the sealed space blocked from the outside is formed in the drying room 10.

Herein, the support frames 12 except the support frame 12 positioned at the rear side of the drying room 10 serve as frames for supporting the drying room 10 such that the shape of the drying room 10 is stabled maintained.

To the contrary, as shown in FIG. 6E, as the use of the drying room 10 is finished, the rotation frame 11 is rotated in the other direction such that the support frame 12, which is connected to the rotation frame 11, and the other support frame 12, which is connected to the support frame 12 connected to the rotation frame 11, are rotated in the other direction together with the rotation frame 11 such that the volume of the drying room 10 is minimized and thus the drying room 10 can be easily stored.

Herein, as shown in FIG. 1 and FIG. 2, the pet drying room 100 further includes a coupling band 131, of which one end portion is coupled and fixed to the rotation frame 11, a female VELCRO® or loop strip 132 formed on one surface of the center portion of the coupling band 131, and a male VELCRO® or hook strip 133 formed on one surface of the other end portion of the coupling band 131, wherein, it is preferable that, in a state, in which the rotation frame 11 is rotated in the other direction so as to be folded, as shown in FIG. 6E, the male VELCRO® strip 133 formed at the end of the coupling band 131 is coupled to the female VELCRO® strip 132, after passing the end of the coupling band 131 through the support frame 12 positioned at the rear side of the drying room 10, such that the volume of the drying room 10 is reduced so as to be easily stored.

Meanwhile, as shown in FIG. 1 and FIG. 2, the pet drying room 100 further includes a fixing band 121, of which one end is coupled to the support frame 12, and a fixing hook 122 coupled to the other end of the fixing band 121, wherein the fixing hook 122 is coupled to the rotation frame 11 so as to prevent the rotation of the rotation frame 11.

That is, as shown in FIG. 6F, the rotation frame 11 is rotated in one direction and the fixing hook 122 formed on the fixing band 121 is held on the rotation frame 11 such that the rotation frame 11 does not come into close contact with the floor but is positioned to float in the air and the inner space of the drying room 10 is naturally opened. Then, the pet drying room 100 can be used as a general house for a pet, reinforcing the availability of the product.

Herein, it is preferable that a mat 2 is arranged on the bottom of the drying room 10 such that a pet can comfortably stay in the drying room 10.

Meanwhile, as for the closing panels 14, it is possible to use any one selected from a soft material and a hard material or the combination thereof, wherein the closing panel of the pet drying room 100 according to the present invention is embodied by combining the both soft and hard materials but not limited thereto.

Herein, as for the soft material, a soft resin material such as vinyl can be used, and as for the hard material, a hard resin material such as plastics can be used, wherein it is preferable that both the soft and hard materials are formed to be transparent such that a user can see the inside of the drying room 10 therethrough.

Meanwhile, as shown in FIG. 1 and FIG. 2, the pet drying room may further include introduction holes 51 formed at both sides of the drying room 10 such that a user can put hands in the drying room 10.

Therefore, as shown in FIG. 6C, in the process of drying a pet accommodated in the drying room 10, a user can put hands in the pet drying room through the introduction holes 51 and comb the hair of the pet so as to prevent the tangles of the long hair of the pet from occurring during the drying process. Therefore, it is possible to provide the convenience for use to users.

Herein, wristlets 52 are provided to the inside of the drying room 10 and communicate with the introduction holes 51 such that the arms of a user, which are inserted into the introduction holes 51, are surrounded by the wristlets 52 and prevented the hair of a pet, which is scattering in the drying room 10, from being attached to the arms of the user. Therefore, the user can cleanly carry out the drying process.

Furthermore, the introduction holes 51 of the pet drying room 100 as well as the lower portion of the drying room 10 may be further provided with covers (not shown) for blocking the introduction holes 51 and precisely seal the drying room 10 from the outside. Therefore, it is possible to more effectively prevent the interior air of the drying room 10 as well as the scattering hair from being discharged to the outside.

As shown in FIG. 1 and FIG. 2, the mounting hole 20 is perforated in the front portion of the drying room 10 and used for mounting a dryer 1, which is normally available at home, so as to inject warm air to the inside of the drying room 10.

That is, as shown in FIG. 6B, if a user fixes the dryer 1 in the mounting hole 20 after a pet is accommodated in the drying room 10 so as to dry the hair of the pet, and operates the dryer 1, then the warm air is supplied to the inside of the drying room 10 and thus the wet hair of the pet is conveniently dried.

Herein, as shown in FIG. 1 and FIG. 2, it is preferable that the pet drying room further includes a dispersion cover 70 to be inserted and fixed in the mounting hole 20 of the drying room 10, and the dispersion cover 70 includes an introduction groove 71, into which the dryer 1 can be inserted, and a plurality of introduction holes 72 formed in the inner peripheral surface and the front portion of the introduction groove 71.

Therefore, as shown in FIG. 6B, if the dryer 1 is operated after the dryer 1 is inserted and fixed in the introduction groove 71 of the dispersion cover 70, warm air is dispersed and discharged through the plurality of introduction holes 72, which are formed in the dispersion cover 70, and the plurality of introduction holes 72 induce the warm air to be uniformly dispersed and supplied such that the hair of the pet accommodated in the drying room 10 can be more effectively dried.

Meanwhile, as shown in FIG. 3, it is preferable that the pet drying room further includes a flexible connection pipe 60, of which inside portion is perforated, and having one end, which is inserted into the mounting hole 20 of the drying room 10 so as to communicate with the inside of the drying room 10 and the other end, into which the dryer 1 is inserted.

Therefore, if the dryer 1, which is available at home, is too small to be arranged and fixed in the mounting hole 20, the one end of the connection pipe 60 is inserted and fixed in the mounting hole 20 and the dryer 1 is simply inserted and fixed in the other end of the connection pipe 60 such that the warm air can be injected to the inside of the drying room 10 through the connection pipe 60.

Herein, since the connection pipe 60 is made from a flexible material and thus the dryer 1 of various size can be inserted and fixed in the connection pipe 60, the dryer 1 of various size can be effectively applied and used through the connection pipe 60.

As shown in FIG. 1 and FIG. 2, the discharge hole 30 is perforated at the rear side of the drying room 10 such that the warm air of the dryer 1, which is introduced through the mounting hole 20, is discharged to the outside through the discharge hole 30.

As shown in FIG. 1 and FIG. 2, the dust collection filter 40 have a plurality of fine holes 41 and is positioned at the rear side of the drying room 10 so as to cover the discharge hole 30.

That is, as shown in FIG. 6B, while the warm air of the dryer 1, which is introduced into the drying room 10, is discharged together with scattering hair through the discharge hole 30, the air is discharged to the outside through the dust collection filter 40 and the scattering hair is collected by the dust collection filter 40 such that it is possible to stably prevent various diseases (allergy reactions, respiratory diseases and the like), which may be caused by the scattering of the pet hair to the outside.

Herein, it is preferable that the dust collection filter 40 is formed to be conveniently attached to or detached from the rear side of the drying room 10 through a typical VELCRO® 3 such that a user can easily recover the dust collection filer 40 and conveniently remove the hair collected by the dust collection filter 40, thereby cleaning the dust collection filer 40.

Meanwhile, as shown in FIG. 1 and FIG. 2, the pet drying room further includes a suction pipe 80 positioned at the rear side of the drying room 10 so as to be coupled to the drying room 10 and of which inside is perforated and one end is connected to and thus communicates with the discharge hole 30, which is provided with the dust collection filter 40.

That is, as shown in FIG. 6D, the one end of the suction pipe 80 is brought into close contact with the dust collection filter 40 so as to communicate with the dust collection filter 40 and then the other end of the suction pipe 80 is connected to a typical vacuum cleaner, which is available at home, such that the interior air of the drying room 10 is forcedly sucked by the suction force of the vacuum cleaner so as to induce the hair scattering in the drying room 10 to be collected by the dust collection filter 40.

Herein, as shown in FIG. 4, instead of the suction pipe 80 and the vacuum cleaner, which generates suction force, it is also possible to provide a suction fan 90 to the discharge hole 30 at the rear side of the drying room 10 such that the air in the drying room 10 can be forcedly sucked and discharged to the outside.

That is, by forcedly sucking and discharging the air in the drying room 10 to the outside through the discharge hole 30, which is provided with the dust collection filter 40, by the operation of the suction fan 90, the hair of a pet, which floats in the drying room 10, is induced to be easily collected by the dust collection filter 40.

Meanwhile, as shown in FIG. 5, the pet drying room may further include a plurality of blower fans 111, which are provided to the drying room 10 and forcedly introduce air from the outside, and a control box 112, which is provided to the drying room 10 and controls the operations of the blower fans 111, such that the air can be forcedly introduced into the drying room 10 from the outside through the blower fans 111 and effective drying work is induced while a pet is accommodated in the drying room 10 and the drying work for the pet is carried out.

The pet drying room 100, according to the present invention, including the above constituent elements as described above can conveniently dry the hair of a pet, which is accommodated in the drying room 10, by mounting the dryer 1, which is available at home, in the mounting hole 20 and operating the dryer 1 so as to inject the warm air into the drying room 10, after the pet is accommodated in the space of the drying room 10. Therefore, various electrical and mechanical elements previously used in the prior art pet dryer devices are not required any more, thereby largely reducing unit costs of products, such that the pet drying room can be used by normal home users without the burden of expenses and ensure versatile use thereof.

In addition, in the process of drying a pet, a user can put hands in the pet drying room 10 through the introduction holes 51 formed in both side surfaces of the drying room 10 and comb the hair of the pet so as to prevent the tangles of the long hair of the pet from occurring during the drying process.

Furthermore, in the process of drying a pet, floating hair can be collected through the dust collection filter 40 positioned at the rear side of the drying room 10 such that it is possible to prevent various diseases (allergy reactions, respiratory diseases and the like), which may be caused by the scattering of the pet hair.

Besides, the pet drying room 10 according to the present invention can be conveniently spread out at the time of use while being simply folded so as to be minimized in volume at the time of storing after use, thereby providing the convenience of storage and maintenance to users.

The pet drying room 100 according to the embodiment of the present invention in the above described structure is used to dry pet hair as follows.

First, as shown in FIG. 6A, in order to dry a pet by using the pet drying room 100, the rotation frame 11 of the drying room 10 is rotated in one direction and brought into close contact with the floor such that a sealed space is conveniently formed in the drying room 10 and a pet to be dried is placed in the space.

After that, as shown in FIG. 6B, a user mounts and fixes the typical dryer 1, which is available at home, in the mounting hole 20 of the drying room 10 and then operates the dryer 1 so as to supply warm air into the drying room 10, such that the wet hair of the pet is conveniently dried.

Herein, the warm air, which is supplied by the dryer 1, is uniformly dispersed and supplied into the drying room 10 by the dispersion cover 70, which is inserted into the mounting hole 20, thereby carrying out efficient drying work.

Simultaneously, as shown in FIG. 6C, the user puts hands in the introduction holes 51, which are formed at both sides of the drying room 10, and combs the hair of the pet such that the tangles of the long hair of the pet is prevented from occurring through the drying.

Meanwhile, as shown in FIG. 6D, the warm air, which is introduced into the drying room 10 by the dryer 1, is discharged together with the scattering hair of the pet through the dust collection filter 40 in the process of drying, wherein the warm air is discharged to the outside through the dust collection filter 40 and the hair is collected by the dust collection filter 40 so as not to be discharged to the outside.

Herein, it is also possible to forcedly suck the air in the drying room 10 through the dust collection filter 40 by the suction force of a typical vacuum cleaner, which is available at home, so as to easily collect the hair scattering in the drying room 10 by the dust collection filter 40, wherein one end of the suction pipe 80 is brought into close contact with the dust collection filer 40 and the vacuum cleaner, which is available at home, is connected to the other end of the suction pipe 80 so as to communicate with the suction pipe 80.

After that, as shown in FIG. 6E, the rotation frame 11 of the drying room 10 is rotated in the other direction as the drying of the pet is finished, such that the volume of the drying room 10 is minimized to be conveniently stored.

Herein, the male VELCRO® strip 133 formed at the end of the coupling band 131 is coupled to the female VELCRO® strip 132 formed in the center of the coupling band, after passing the end of the coupling band 131, which is connected to the rotation frame 11, through the support frame 12, which is positioned at the rear side of the drying room 10, such that the VELCRO® strips are stably coupled and fixed in the state, in which the volume of the drying room 10 is reduced, and thus the drying room 10 can be easily stored.

As described above, while the present invention has been particularly shown and described with reference to the example embodiments thereof, it will be understood by those of ordinary skill in the art that the above embodiments of the present invention are all exemplified and various changes, modifications and equivalents may be made therein without changing the essential characteristics and scope of the present invention. Therefore, it would be understood that the present invention is not limited to the forms described in the example embodiments and the technical and protective scope of the present invention shall be defined by the following claims. In addition, it should be also understood that all modifications, changes and equivalences within the technical scope of the present invention defined by the following claims belong to the technical scope of the present invention.

What is claimed is:

1. A pet drying room, comprising:
a drying room having a space formed to accommodate a pet therein;
a mounting hole perforated in a front portion of the drying room;
a discharge hole perforated in a rear portion of the drying room;
a dust collection filter positioned at a rear side of the drying room so as to close the discharge hole and having a plurality of holes formed therein;
wherein the drying room comprises:
a rotation frame formed in a reversed U shape and comprising rotation protrusions, which are formed at both ends thereof so as to be respectively extended inwards, and threads, which are formed on outer circumferences of the rotation protrusions;
a plurality of support frames formed in a reversed U shape and respectively comprising rotation holes formed at both ends such that a rotation protrusion formed at one end of the rotation frame is insertable into the rotation holes formed at one end of each of the plurality of support frames and a rotation protrusion formed at the other end of the rotation frame is insertable into the rotation holes formed at the other end of each of the plurality of support frames;
fixing nuts respectively coupled to the rotation protrusions, which are formed at the both ends of the rotation frame, so as to prevent a separation of the support frames, which are insertable into the rotation protrusions of the rotation frame;
closing panels formed between the rotation frame and a support frame closest to the rotation frame, and between other support frames so as to close space portions between the rotation frame and the support frame closest to the rotation frame, and between the other support frames;
wherein the support frames are rotated together with the rotation frame in sequence by the closing panels in response to the rotation frame being rotated or unfolded and in response to the rotation frame coming into contact with a floor, such that a sealed space is formed to accommodate a pet therein; and
wherein the support frames are rotated together with the rotation frame in response to the rotating frame being folded such that a sealed space is opened.

2. The pet drying room according to claim 1, further comprising introduction holes formed at both sides of the drying room to enable a user to place hands in the drying room through the introduction holes.

3. The pet drying room according to claim 1, further comprising a flexible connection pipe with a perforated inside and comprising one end insertable into the mounting hole of the drying room so as to communicate with inside of the drying room and other end through which a dryer is insertable.

4. The pet drying room according to claim 1, further comprising a dispersion cover insertable and fixed in the mounting hole of the drying room and comprising an introduction groove, into which a dryer is insertable, and a plurality of introduction holes formed in an inner peripheral surface and a front surface of the introduction groove, wherein hot air from the dryer is dispersed and discharged through the plurality of introduction holes to the dispersion cover to be uniformly dispersed and supplied to inside of the drying room.

5. The pet drying room according to claim 1, further comprising a suction pipe, with a perforated inside portion, positioned at the rear side of the drying room and comprising one end connected to and communicating with the discharge hole provided with the dust collection filter.

6. The pet drying room according to claim 1, wherein the closing panels employ one of the following: a vinyl material, a plastic material or a combination thereof.

7. The pet drying room according to claim 1, comprising a fixing band with one end coupled to the support frame closest to the rotation frame; and a fixing hook coupled to other end of the fixing band and to the rotation frame to prevent a rotation of the rotation frame.

8. The pet drying room according to claim 1, further comprising:
a coupling band with one end portion coupled and fixed to the rotation frame;
a loop strip formed on one surface of a center portion of the coupling band;
a hook strip formed on one surface of other end portion of the coupling band;
wherein an end of the coupling band passes through the support frame positioned at the rear side of the drying room to couple the hook strip formed at an end of the coupling band to the loop strip in a folded state of the rotation frame, such that a volume of the drying room is reduced so as to be easily stored.
